(19) United States
(12) Patent Application Publication
(10) Pub. No.: US 2006/0012300 A1
(43) Pub. Date: Jan. 19, 2006

(54) Sealing material structure of organic electroluminescent display panel and method for manufacturing the same

(76) Inventors: Wen-Jeng Lan, Chu-Nan (TW); Chin Chung Chang Chien, Chu-Nan (TW); Ming Te Lee, Chu-Nan (TW); Yen Shan Lin, Chu-Nan (TW); Shih Chia Chen, Chu-Nan (TW); Yun Sen Lai, Chu-Nan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/179,595

(22) Filed: Jul. 13, 2005

(30) Foreign Application Priority Data
Jul. 13, 2004 (TW) 093120922

(51) Int. Cl. H05B 33/04

(52) U.S. Cl. 313/512; 445/24

(57) ABSTRACT

A sealing material structure of an organic electroluminescent display panel and a method for manufacturing the same are provided. The sealing material structure comprises a glass substrate, a cover, an adherent layer, and a barrier area. The glass substrate has a light emitting display structure formed thereon and wraps an organic light emitting structure of the light emitting display structure. The cover seals with the glass substrate in an opposite position. The adherent layer is provided between the glass substrate and the cover. The barrier area and/or fillister is grown on the glass substrate and provided at least one side of the adherent layer. Thereby the light emitting display structure and the organic light emitting structure cooperate to constitute an internal structure; the barrier area can isolate external electrodes affected the internal structure spilled from the adherent layer and widely provided around the internal structure and the barrier area can isolate inner of panel cutting line affected the panel cutting process spilled from the adherent layer and widely provided inner the panel cutting line.

### FIELD OF THE INVENTION

The present invention is related to an organic electroluminescent display panel, and more particularly to an organic electroluminescent display panel with an external sealing material structure with barrier area and/or a fillister.

### BACKGROUND

Organic electroluminescence respectively evaporates various organic materials to films on a glass substrate plated with ITO film by means of vacuum hot evaporation and then forms a metallic thin film as a cathode on an organic layer. Next, to prevent external mist from worsening lifetime of organic electroluminescent device, UV adhesive is used to tightly joint the cover pasted with a desiccant with the cover to resist mist from invading. The feature of the organic electroluminescent technology comprises: self-light emitting, direct current low voltage driven (below 10V), high light emitting efficiency, low power, abundant light emitting colors, easy to achieve color display, simple techniques, low cost, outstanding temperature feature, light emitting function independent of temperatures. Comparing with liquid crystal displays the advantages of the organic electroluminescent displays are: (1) no visual angle problems; (2) thickness thinner than the liquid crystal displays; (3) the cost of production in a large number comparing favorably with the liquid crystal displays; (4) response time better than the liquid crystal displays; (5) able to display in low temperatures, while the liquid crystal displays having slower response time in low temperatures. Even if the organic electroluminescence is a burgeoning technology currently, quite a bit difficulty are encountered in real applications, including: stability of maintaining light emitting in a very short time and difficulty of light emitting efficiency came from larger panels, waterproof packages came from the organic materials themselves and usage lifetime problems, disproportion of light emitting brightness and color caused by non-uniformity of the organic materials, etc.

The lifetime of existed organic electroluminescent materials can achieve up to 15,000 hours in average, yet being to apply in real mass produced products. If the pollution and erosion of mist can be completely prevented, the lifetime of elements can be further up-raised. The packaging method of Pioneer Electronic Corporation and NEC Company Limited refers to a sealing material structure of a prior art organic electroluminescent display panel as shown in FIG. 1. A cover 2a is tightly sealed with a glass substrate 10a through UV resin 3a with low moist penetration after attaching with powerful absorbent to achieve an effect of slowing down mist invading. Among them, the joint resin preventing mist from invading normally meets mass production conditions of low temperature and hardening in a short time. Mostly UV epoxy resin with low moist penetration is adopted. Meanwhile, general joint resin sets free a small amount of organic matter and moisture content more or less, and thus affecting the long-term lifetime of OEL device. In addition, when pressing the sealing material, UV resin 3a has problems of easily overflowing to effect the active area of internal OEL device, panel cutting and module attaching later on, and thus affecting the cutting process of panel. Besides, when the UV resin 3a is in a state of overflowing colloid, the colloid overflowing situations and colloid overflowing areas cannot be controlled. Therefore, the sealing material area and sealing material manufacturing states cannot be conditioned, unfavorable to the process in mass production.

Therefore, the inventor diligently studied and operated in coordination with theories to bring up the present invention with reasonable design and effectively improving the above mentioned shortcomings in respect to the above mentioned shortcomings.

### SUMMARY OF THE INVENTION

It is a primary object of the present invention to provide a sealing material structure of an organic electroluminescent display panel and a method for manufacturing the same which avoids from overflowing glue to the active area of internal OEL device in pressing the scaling materials to avoid from affecting the active area of internal device.

It is a secondary object of the present invention to provide a sealing material structure of an organic electroluminescent display panel and a method for manufacturing the same which further accurately controls the height of the sealing material.

It is another object of the present invention to provide a sealing material structure of an organic electroluminescent display panel and a method for manufacturing the same which explicitly defines the area of manufacturing the sealing material.

It is yet object of the present invention to provide a sealing material structure of an organic electroluminescent display panel and a method for manufacturing the same which reduces the effect to the usage lifetime of the products by organic matter and water set free by the organic adhesive.

It is other object of the present invention to provide a scaling material structure of an organic electroluminescent display panel and a method for manufacturing the same which avoid from overflowing glue to the cutting line of panel in pressing the sealing materials to avoid from affecting the yield of panel cutting and breaking.

To achieve the previous mentioned objects, the present invention provides a sealing material structure of an organic electroluminescent display panel comprising a glass substrate, a cover, an adherent layer, and a barrier area. The glass substrate has a light emitting display structure formed thereon and wraps an organic light emitting structure of the light emitting display structure. The cover seals with the glass substrate in an opposite position. The adherent layer is provided between the glass substrate and the cover. The barrier area is grown on the glass substrate and provided at least one side of the adherent layer. Thereby the light emitting display structure and the organic light emitting structure cooperate to constitute an internal structure; the barrier area can isolate external electrodes affected the internal structure spilled from the adherent layer and widely provided around the internal structure.

To achieve the previous mentioned objects, the present invention provides a process of manufacturing an organic (a) making a glass substrate; (b) growing and photolithography, etching a light emitting display structure on the glass substrate; (c) growing and photolithography, etching a barrier on the glass substrate; (d) growing an organic light emitting structure on the obtained structure to cooperate with the light emitting display structure to form an internal structure; (e) filling an adherent layer on the glass substrate; and (f) packaging the obtained structure and a cover; wherein the barrier area is provided at least one side of the adherent layer; thereby the barrier area is used to isolate external electrodes spilled into the internal structure from the adherent layer and widely provided around the internal structure.

For examiners to further understand the feature and technical content of the present invention, please refer following detailed description and accompanying drawings of the present invention. However, the accompanying drawings are only for reference and description, not for limiting the present invention.

### BRIEF DESCRIPTION OF DRAWINGS

FIG. 1 shows a side view cross section diagram of a sealing material structure of a prior art organic electroluminescent display panel;

FIG. 2 shows a side view cross section diagram of a first embodiment of a sealing material structure of an organic electroluminescent display panel of the present invention;

FIG. 3 shows a side view cross section diagram of a second embodiment of a sealing material structure of an organic electroluminescent display panel of the present invention;

FIG. 4 shows a side view cross section diagram of a third embodiment of a sealing material structure of an organic electroluminescent display panel of the present invention:

FIG. 5 shows a side view cross section diagram of a fourth embodiment of a sealing material structure of an organic electroluminescent display panel of the present invention;

FIG. 5A shows a side view cross section diagram of a fifth embodiment of a sealing material structure of an organic electroluminescent display panel of the present invention;

FIG. 6A to FIG. 6I show flow charts of the first embodiment of the sealing material structure of the organic electroluminescent display panel of the present invention;

FIG. 7A to FIG. 7I show flow charts of the second embodiment of the sealing material structure of the organic electroluminescent display panel of the present invention;

FIG. 8A to FIG. 8K show flow charts of the third embodiment of the sealing material structure of the organic electroluminescent display panel of the present invention; and

FIG. 9A to FIG. 9L show flow charts of the fourth embodiment of the sealing material structure of the organic electroluminescent display panel of the present invention.

### DETAILED DESCRIPTION

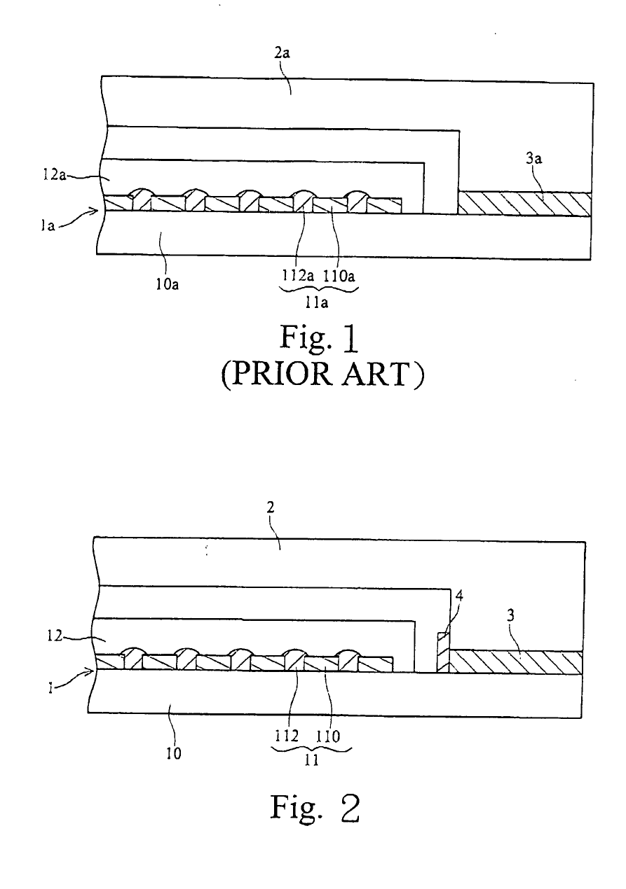

Please refer to FIG. 2, an organic electroluminescent display panel provided by the present invention comprising a glass substrate 10, a light emitting display structure 11 provided on the glass substrate 10, an organic light emitting structure 12 including HIL, HTL, EML, ETL, EIL and cathode so on, wrapping the light emitting display structure 11, and a cover wrapping the organic light emitting structure 12. Among them, the light emitting display structure 11 comprises an ITO conductive layer 110 and an isolation area 112 as isolation in the ITO conductive layer. The light emitting display structure 11 and the organic light emitting structure 12 cooperate to combine into an internal structure 1. A first embodiment of a sealing material structure of the organic electroluminescent display panel provided by the present invention has an adherent layer 3 tightly connected between the cover 2 and the glass substrate 10 and a barrier area 4 grown in the surroundings near the internal structure of the adherent layer 3. Among them, the barrier area 4 is made of polyimide, other photoresist materials, silicon oxide, silicon nitride, silicon oxide nitride, or other inorganic materials. The barrier area 4 is grown on the glass substrate 10. The glass substrate 10 can avoid from a glue overflowing circumstance of the adherent layer 3 generated when packaging the cover 2 and the glass substrate 10 and thus avoid from highly hard to control the sealing material generated by overflowing glue and polluting the active area of the internal structure and the area of panel cutting line. Furthermore, the barrier area 4 can truly isolate the adherent layer 3 from the internal structure 1 to reduce the effect to the usage lifetime of the products by organic matter and water set free by the organic adhesive.

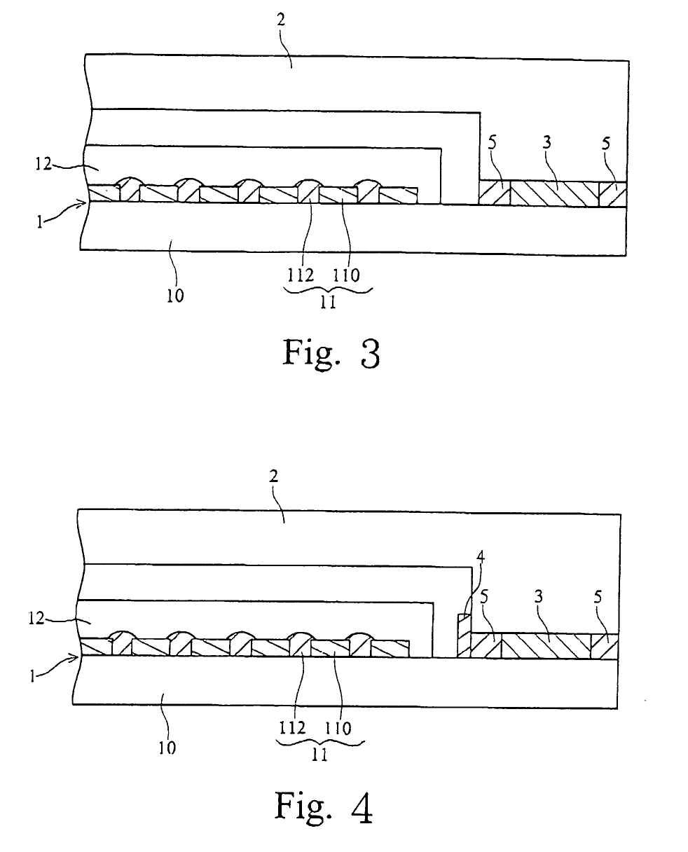

Please refer to a second embodiment of the sealing material structure of the organic electroluminescent display panel of the present invention as shown in FIG. 3, comprising an adherent layer 3 tightly connected between the cover 2 and the glass substrate 10 and a barrier area 5 grown in the surroundings and around the outer side near the internal structure 1 of the adherent layer 3. The barrier area 5 forms a space for containing the adherent layer 3 by means of bilateral support which more effectively controls the package height of the adherent layer 3 and defines the sealing material area.

Please refer to a third embodiment of the sealing material structure of the organic electroluminescent display panel of the present invention as shown in FIG. 4, comprising an adherent layer 3 tightly connected between the cover 2 and the glass substrate 10, a barrier area 4 grown in the surroundings near the internal structure 1 of the adherent layer 3, and a barrier area 5 grown between the adherent layer 3 with the barrier area 4 and around the outer side thereof.

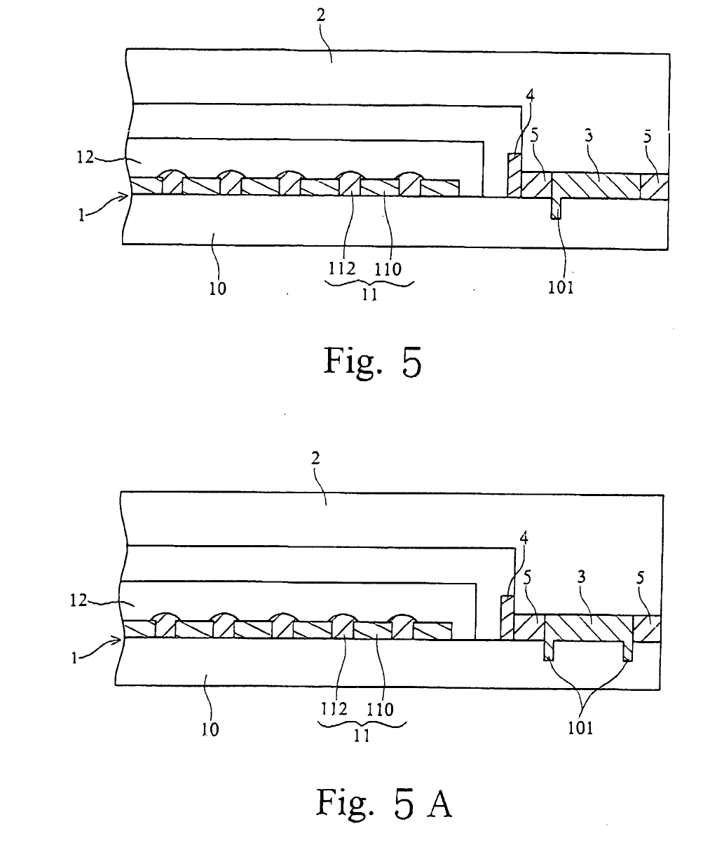

Please refer to FIG. 5 and FIG. 5A, a fourth and a fifth embodiment of a sealing material structure of an organic electroluminescent display panel of the present invention, comprising an adherent layer 3 tightly connected between the cover 2 and the glass substrate 10, a barrier area 4 grown in the surroundings near the internal structure 1 of the adherent layer 3, and a barrier area 5 grown between the adherent layer 3 with the barrier area 4 and around the outer side thereof, respectively. Among them, the glass substrate 10 forms at least one fillister 101 at where the adherent layer 3 is provided. Therefore, when the cover 2 and the glass substrate 10 proceed packaging and oppressing the adherent layer 3, the fillisters 101 can be made by means of photolithography, etching technology to provide a space to contain the adherent layer 3 fleeing hither and thither to guarantee that the adherent layer 3 will not have a clue overflowing situation.

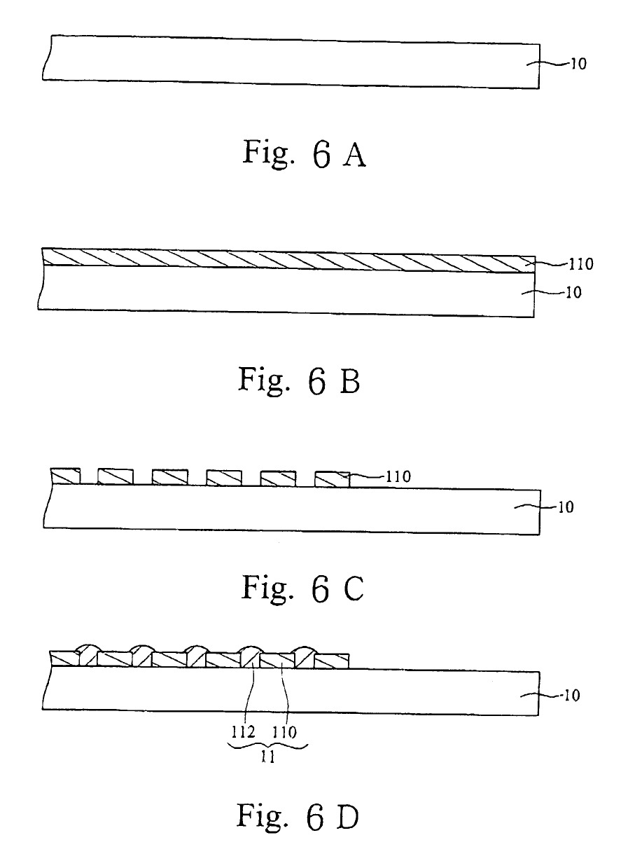

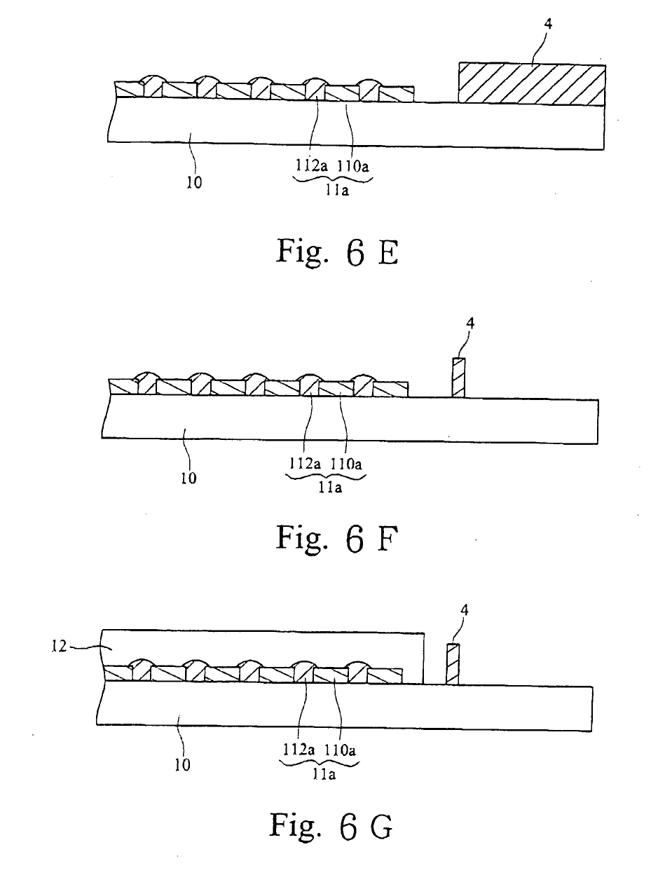

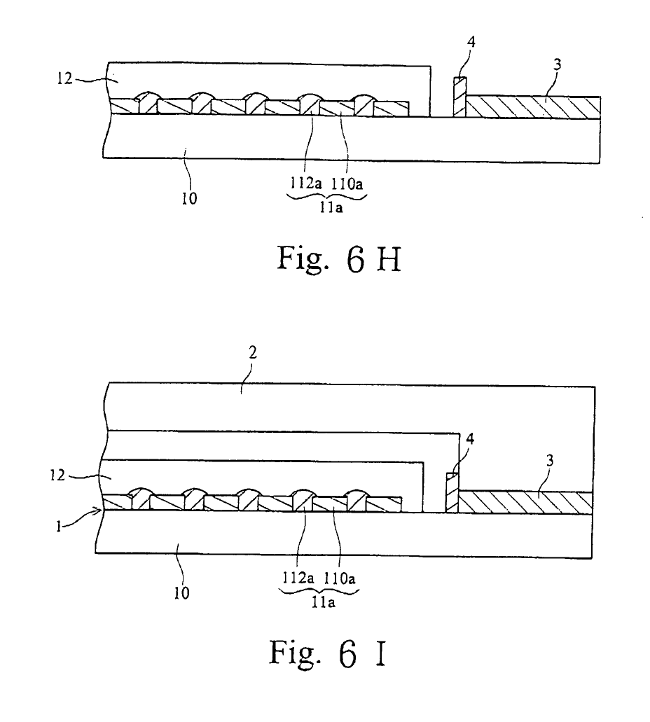

Please refer to FIG. 6A to FIG. 6I, manufacturing flow charts of the first embodiment in accordance with the present invention which comprises the steps of. (a) using chemicals, such as detergent and so on, and water to wash to make a glass substrate 10; (b) growing and photolithography, etching an ITO conductive layer 110, at least one metallic pattern layer, and an isolation area 112 as an isolation on the metallic pattern layer on the glass substrate 10; (c) growing and photolithography or/and etching a barrier area 4 on the glass substrate 10; (d) growing an organic light emitting structure 12 on the obtained structure to cooperate with the light emitting display structure 11 to form an internal structure 1; (e) filling an adherent layer 3 outside of the barrier area 4; and (f) packaging the obtained structure and the cover 2; thereby the barrier area 4 is used to isolate from the adherent layer 3 spilling into the internal structure 1 avoid spilling into the cutting line of panel. The barrier area 4 can have a predetermined height higher than the adherent layer 3 to guarantee the isolation effect.

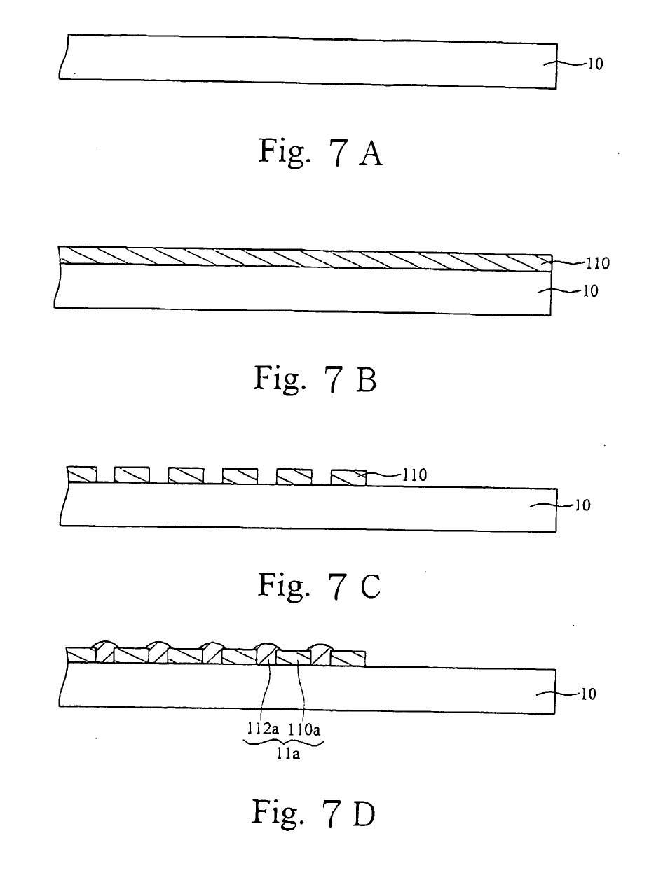

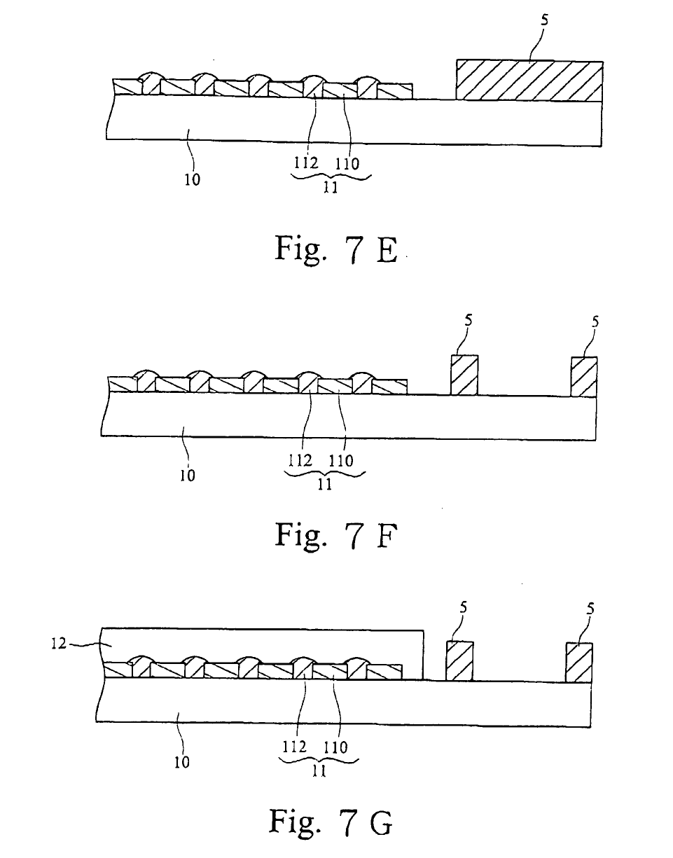

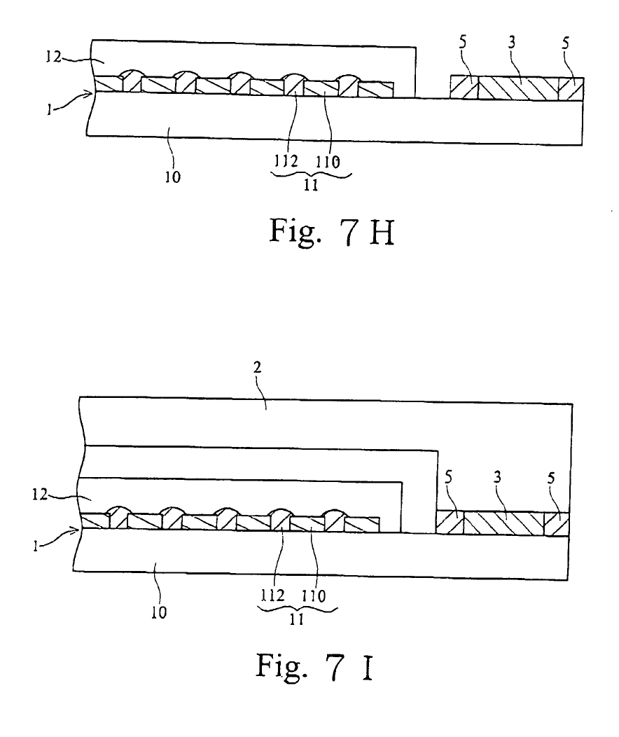

Please refer to FIG. 7A to FIG. 7I, manufacturing flow charts of manufacturing the second embodiment in accordance with the present invention which comprises the steps of: (a) using chemicals, such as detergent and so on, and water to wash to make a glass substrate 10; (b) growing and photolithography, etching an ITO conductive layer 110, at least one metallic pattern layer, and an isolation area 112 as an isolation on the metallic pattern layer on the glass substrate 10; (c) growing and photolithography or/and etching a parallel provided barrier area 5 on the glass substrate 10; (d) growing an organic light emitting structure 12 on the obtained structure to cooperate with the light emitting display structure 11 to form an internal structure 1; (e) filling an adherent layer 3 in a space of the barrier area 5; and (f) packaging the obtained structure and the cover 2; thereby the parallel provided barrier area 5 can effectively control the capacity of the glue dropped each time and further avoid from the adherent layer 3 spilling into the internal structure 1.

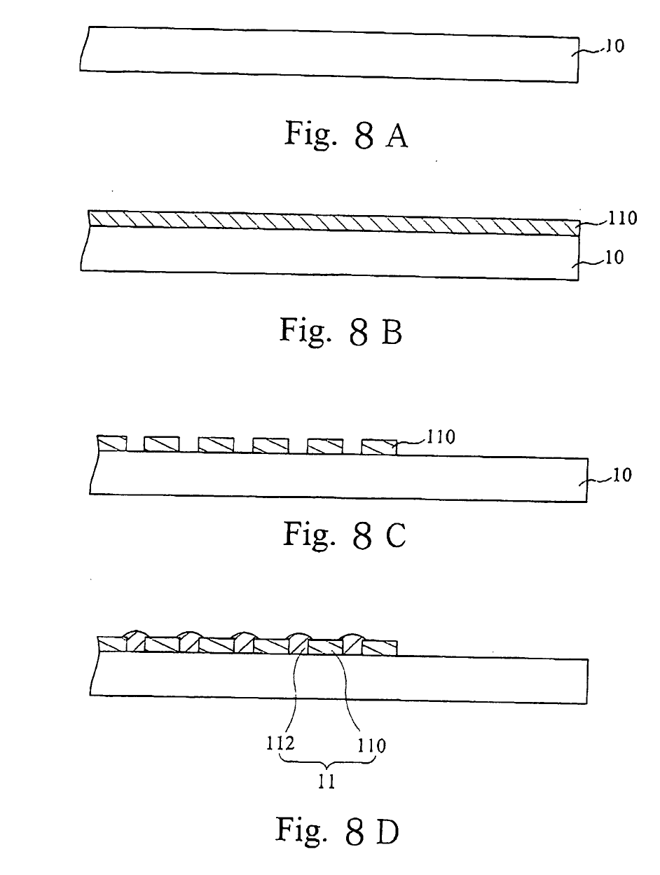

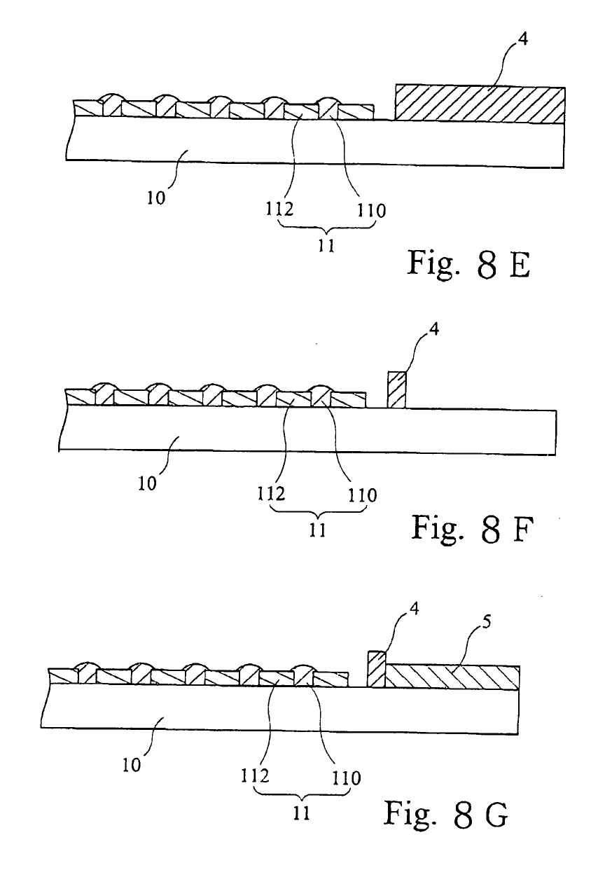

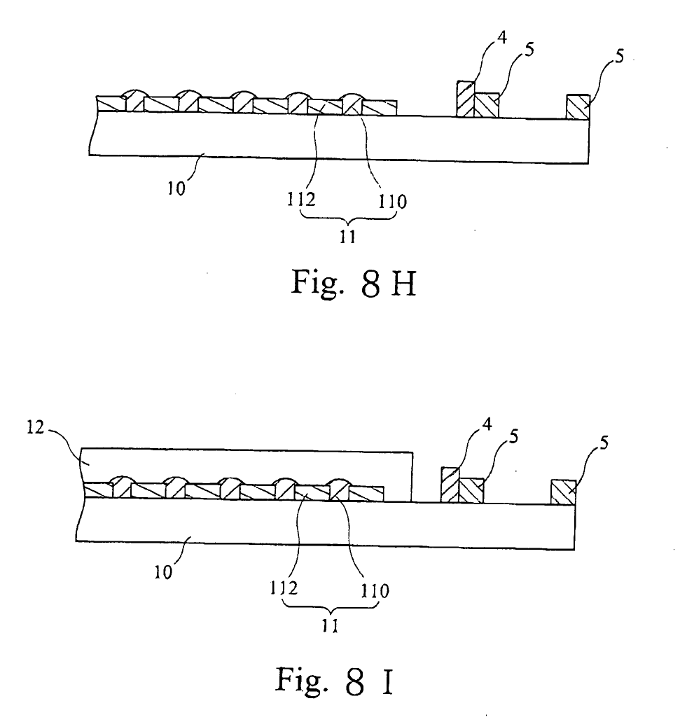

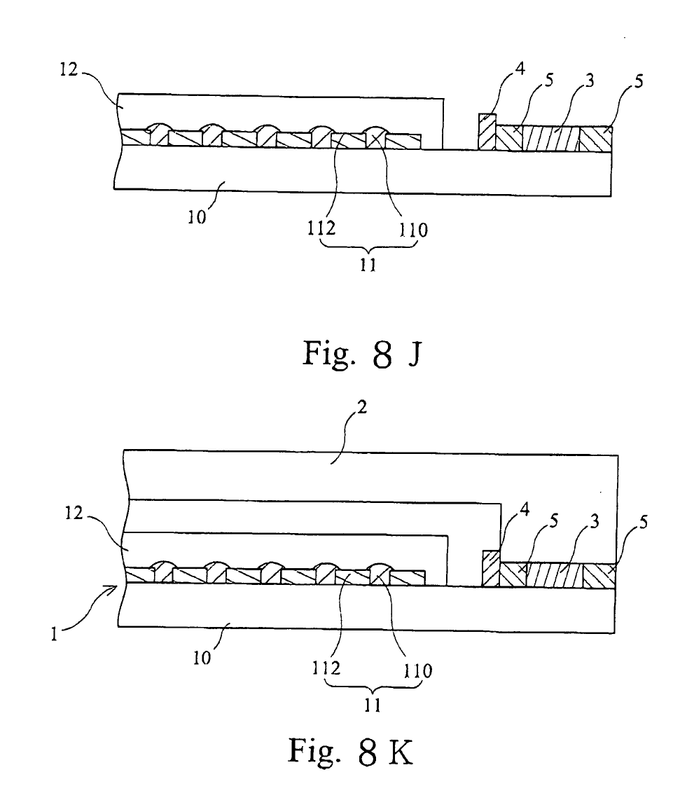

Please refer to FIG. 8A to FIG. 8K, manufacturing flow charts of manufacturing the third embodiment in accordance with the present invention which comprises the steps of: (a) using chemicals, such as detergent and so on, and water to wash to make a glass substrate 10; (b) growing and photolithography, etching light emitting display structures 11, such as an ITO conductive layer 110, at least one metallic pattern layer, and an isolation area 112 as an isolation on the metallic pattern layer on the glass substrate 10; (c) growing and photolithography or/and etching a barrier area 4 on the glass substrate 10; (d) growing and photolithography or/and etching a parallel provided barrier area 5 on the glass substrate 10; (e) growing an organic light emitting structure 12 on the obtained structure to cooperate with the light emitting display structure 11 to form an internal structure 1; (f) filling an adherent layer 3 in a space of the barrier area 5; and (g) packaging the obtained structure and the cover 2; thereby the parallel provided barrier area 5 can effectively control the capacity of the glue dropped each time and further avoid from the adherent layer 3 spilling into the internal structure 1; the barrier area 4 can have a predetermined height slightly higher than the barrier area 5 to prevent from the adherent layer 3 spilling out by any chance.

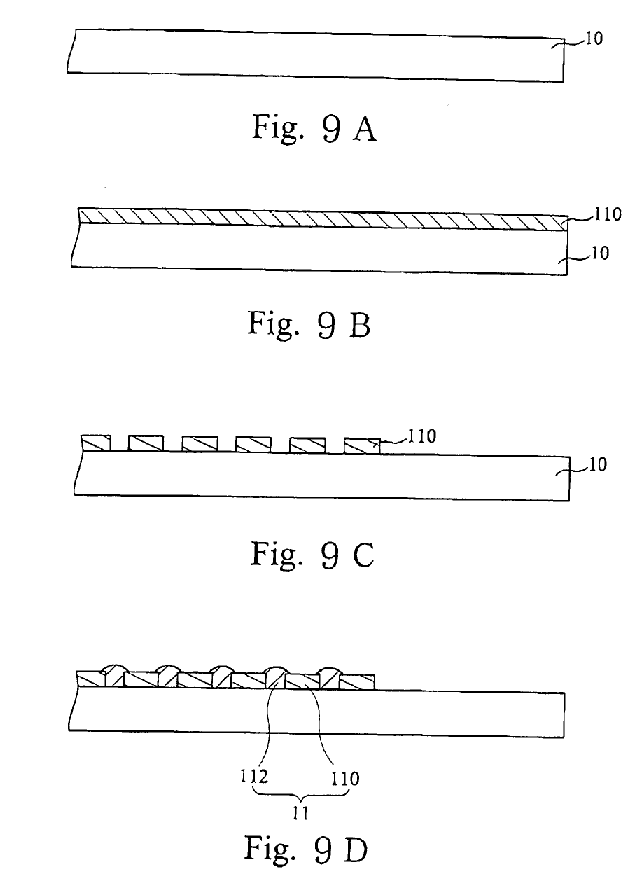

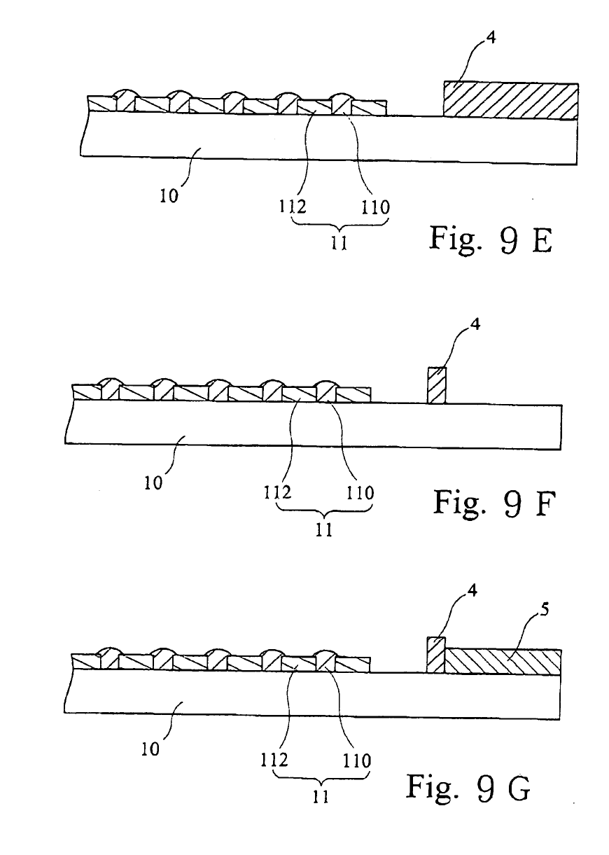

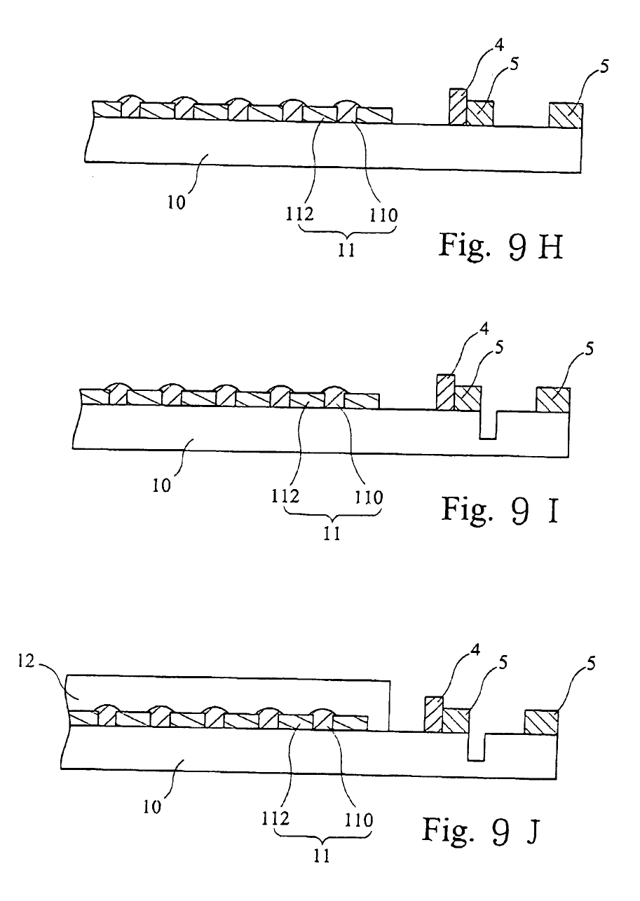

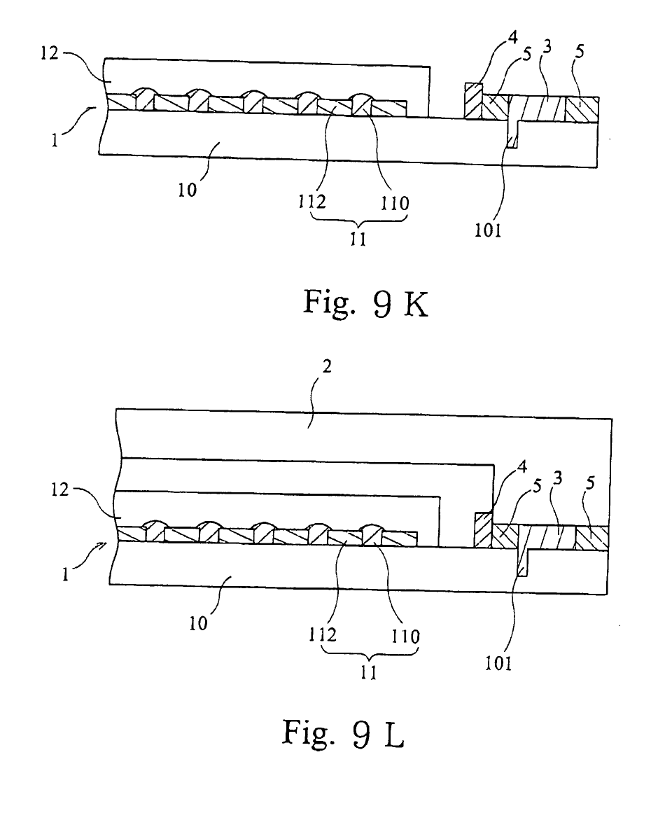

Please refer to FIG. 9A to FIG. 9L, manufacturing flow charts of manufacturing the fourth embodiment in accordance with the present invention which comprises the steps of: (a) using chemicals, such as detergent and so on, and water to wash to make a glass substrate 10; (b) growing and photolithography, etching light emitting display structures 11, such as an ITO conductive layer 110, at least one metallic pattern layer, and an isolation area 112 as an isolation on the metallic pattern layer on the glass substrate 10; (c) growing and photolithography or/and etching a barrier area 4 on the glass substrate 10; (d) growing and photolithography or/and etching a parallel provided barrier area 5 on the glass substrate 10; (e) growing an organic light emitting structure 12 on the obtained structure to cooperate with the light emitting display structure 11 to form an internal structure 1; (f) filling an adherent layer 3 in a space of the barrier area 5; and (g) packaging the obtained structure and the cover 2; wherein before step (f), including in step (b) and around steps (e) and (d), photolithography, etching the glass substrate 10 to have at least one fillister 101 can be further comprised. In this embodiment, the step of etching the glass substrate 10 is after step (e). Thereby, the parallel provided barrier area 5 can effectively control the capacity of the glue dropped each time and further avoid from the adherent layer 3 spilling into the internal structure 1. The barrier area 4 can have a predetermined height slightly higher than the barrier area 5 to prevent from the adherent layer 3 spilling out by any chance. When the cover 2 and the glass substrate 10 proceed packaging and oppressing the adherent layer 3, the fillisters 101 can be made by means of photolithography, etching technology to provide a space to contain the adherent layer 3 fleeing hither and thither to guarantee that the adherent layer 3 will not have a glue overflowing situation.

The sealing material structure of the organic electroluminescent display panel and the method for manufacturing the same of the present invention has following advantages:

1. Growing the barrier 4 or 5 can avoid from spilling glue to effect the active area of internal device when pressing the sealing material and avoid spilling glue overflow the cutting line of panel from the panel cutting process.

2. More effectively control the package height of the adherent layer 3 and define the sealing material area.

3. Reduce the effect to the usage lifetime of the products by organic matter and water set free by the organic adhesive.

In summary, the present invention can truly achieve anticipated objects and effects. However, the above disclosed technical means is only a preferred embodiment of the present invention, and all equivalent variations and modifications in process, method, feature, and spirit in accordance with the appended claims may be made without in any way from the scope of the invention.

### LIST OF REFERENCE SYMBOLS

The prior art sealing material structure of the organic electroluminescent display panel

2a cover
3a UV resin
10a glass substrate
   The sealing material structure of the organic electroluminescent display panel provided by the present invention
1 internal structure
10 glass substrate
101 fillister
11 light emitting display structure
110 ITO conductive layer
112 isolation area
12 organic light emitting structure
2 cover
3 adherent layer
4,5 barrier area

1. A sealing material structure of an organic electroluminescent display panel, comprising:
a glass substrate having a light emitting display structure formed thereon and wrapping an organic light emitting structure of said light emitting display structure;
a cover for sealing with said glass substrate in an opposite position;
an adherent layer provided between said glass substrate and said cover;
a barrier area grown on said glass substrate and provided at least one side of said adherent layer;
wherein said light emitting display structure and said organic light emitting structure cooperate to constitute an internal structure; said barrier area can isolate to avoid the effect said internal structure spilled from said adherent layer and widely provided around said internal structure, and can isolate to avoid effect said panel cutting process spilled from said adherent layer and widely provided inner said cutting line.

2. The sealing material structure of an organic electroluminescent display panel according to claim 1, wherein said barrier area is provided at one side near said internal structure in said adherent layer.

3. The sealing material structure of an organic electroluminescent display panel according to claim 1, wherein said barrier area is provided at an outer side and said opposite side thereof near said internal structure in said adherent layer provided in a space of said barrier area.

4. The sealing material structure of an organic electroluminescent display panel according to claim 1, further comprising a fillister area formed on said glass substrate and provided at least one side of said adherent layer.

5. The sealing material structure of an organic electroluminescent display panel according to claim 1, wherein said barrier area is provided at an outer side and said opposite side thereof near said internal structure in said adherent layer provided in a space of said barrier area.

6. The sealing material structure of an organic electroluminescent display panel according to claim 1, wherein said barrier area is provided at an inner side and said opposite side thereof near the cutting line of panel cutting process in said adherent layer provided in a space of said barrier area.

7. The sealing material structure of an organic electroluminescent display panel according to claim 1, wherein said barrier area can be made from one of materials of polyimide, other photoresistive materials and inorganic materials.

8. The sealing material structure of an organic electroluminescent display panel according to claim 7, wherein said inorganic materials can be selected as a material of silicon oxide, silicon nitride, silicon oxide nitride and inorganic materials.

9. A method for manufacturing a sealing material structure of an organic electroluminescent display panel, comprising:
making a glass substrate;
growing and photolithography, etching a light emitting display structure on said glass substrate;
growing and photolithography, etching a barrier area on said glass substrate;
growing an organic light emitting structure on said obtained structure to cooperate with said light emitting display structure to form an internal structure;
filling an adherent layer on said glass substrate; and
packaging said obtained structure and a cover;
wherein said barrier area is provided at least one side of said adherent layer;
wherein said barrier area is used to isolate external electrodes spilled into said internal structure from said adherent layer and widely provided around said internal structure.

10. The method for manufacturing a sealing material structure of an organic electroluminescent display panel according to claim 9, wherein said barrier area is grown at one side near said internal structure in said adherent layer.

11. The method for manufacturing a sealing material structure of an organic electroluminescent display panel according to claim 9, wherein said barrier area is provided at an outer side and said opposite side thereof near said internal structure in said adherent layer provided in a space of said barrier area.

12. The method for manufacturing a sealing material structure of an organic electroluminescent display panel according to claim 9, further comprising photolithography, etching said glass substrate to have at least one fillister before filling said adherent layer on said glass substrate.

13. The method for manufacturing a sealing material structure of an organic electroluminescent display panel according to claim 9, further comprising photolithography etching said glass substrate to have at least one fillister include growing and photolithography, etching a light emitting display structure on said glass substrate.

14. The method for manufacturing a sealing material structure of an organic electroluminescent display panel according to claim 9, further comprising photolithography, etching said glass substrate to have at least one fillister before growing and photolithography, etching a barrier on said glass substrate.

15. The method for manufacturing a scaling material structure of an organic electroluminescent display panel according to claim 9, wherein said adherent layer can be selectively filled on said cover.
